(19) United States
(12) Patent Application Publication
(10) Pub. No.: US 2005/0052450 A1
(43) Pub. Date: Mar. 10, 2005

(54) Video game apparatus and control method thereof

(76) Inventors: Yoshiaki Koizumi, Kyoto (JP); Koichi Hayashida, Kyoto (JP); Takeshi Hayakawa, Kyoto (JP)

Correspondence Address: NIXON & VANDERHYE, P.C., 1100 N. GLEBE ROAD, 8TH FLOOR, ARLINGTON, VA, 22201, US

(21) Appl. No.: 10/436,156

(22) Filed: May 13, 2003

(30) Foreign Application Priority Data
May 16, 2002 (JP) 2002-143542

(51) Int. Cl. G06T 15/00

(52) U.S. Cl. 345/419

(57) ABSTRACT

A video game apparatus includes a CPU and a GPU, and the GPU displays a virtual 3-dimension space on a game screen according to a graphics command from the CPU. A player character, an enemy character and a still object are displayed on the game screen. By setting an action restriction area (graffiti) in a moving locus of the enemy character and making the player character use a pump by a game player, a canceled area in which the graffiti is erased is formed. In the action restriction area, damage occurs to the player character.

### BACKGROUND OF THE INVENTION

1. Field of the Invention

The present invention relates to a video game apparatus and a control method thereof, and a game program. More specifically, the present invention relates to a novel video game apparatus and a control method thereof, and a game program utilized therefore for erasing an area (hereinafter, called as “action restriction area”) in which an action of a player character is restricted or the player character is damaged in a game that a game player operates the player character in a virtual 3-dimension game space.

2. Description of the Prior Art

By recent development of computer graphics, a game apparatus in which a virtual 3-dimension game space is set and in which a game player plays a game by operating a player character is provided in various ways and has a high processing speed and an ascetically pleasant image.

More specifically, paste of a texture to a 3-dimension object has been performed for the purpose of pursuit of a reality. In order to enhance presence of the game and improving reality of the racing game, an art for representing a locus passed by a racing car on a racing course, representing a change by pasting a smudged texture with increasing orbits of the racing car and by erasing the texture with the passage of time is known (e.g., Japanese Patent Application Laying-open No. 2001-167291).

However, in the prior art, high performance of a recent game apparatus is focused on pursuit of reality and not focused on realizing an interest of a game itself.

### SUMMARY OF THE INVENTION

Therefore, it is a primary object of the present invention to provide a novel video game apparatus and a control method thereof, and a game program.

Another object of the present invention is to provide a novel video game apparatus and a control method thereof, and a game program for setting an action restriction area to restrict an action of a player character in a virtual 3-dimension space.

A video game apparatus according to the present invention comprises: a map data storing means (70d: a part corresponding in the embodiment, and so forth) for storing map data to display a virtual 3-dimension space on a display screen of a monitor;
a player character data storing means (70a, 72a) for storing player character data to display a player character (76) in the virtual 3-dimension space; a still object data storing means (72c, 72da) for storing still object data to display a still object (80) in the virtual 3-dimension space; a setting means (36, 70b, S23) for setting an action restriction area to restrict an action of the player character in the virtual 3-dimension space; a canceling means (36, S27) for canceling at least a part of the action restriction area set by the setting means in response to a predetermined action of the player character; an action restriction area storing means (72db) for storing a latest action restriction area by storing in real time the action restriction area (82) set by the setting means and storing in real time a cancelled area (86) cancelled by the canceling means; and a rendering means (36, 42, S8) for rendering the action restriction area in the virtual 3-dimension space on the basis of the action restriction area stored in the action restriction area storing means.

It is also possible to provide in the video game apparatus a clear determining means (70c, S10) for determining stage-clear on the basis of the latest action restriction area stored in the action restriction area storing means.

It is also possible to provide in the video game apparatus a game over determining means (70c, S11) for determining a game-over on the basis of the latest action restriction area stored in the action restriction area storing means.

In a case the video game apparatus includes a plane map storing means (70d) for storing a 2-dimension plane map corresponding to the virtual 3-dimension space and a plane map texture storing means (72db) for storing a plane map texture rendered on the plane map, the action restriction area setting means sets the action restriction area in the plane map texture, and the action restriction area storing means includes the plane map texture storing means.

When the game apparatus further includes a still object data generating means (72c) for generating still object data indicative of a shape of a still object and a still object texture storing means (72d) for storing a still object texture, the still object is displayed by mapping the still object texture on the still object data, and the rendering means includes a texture mapping means (S35) for mapping the still object texture and the plane map texture.

It is noted that it is also possible to set the action restriction area by a transparency parameter of the plane map texture storing means.

Then, in a case the video game apparatus further includes a non-player character data storing means (70b, 72b) for storing non-player character data to display a non-player character (78) in the virtual 3-dimension space, the action restriction area setting means can set the action restriction area depending upon a moving locus of the non-player character.

A control method of a video game according to the present invention is applied to a video game in which a game player operates a player character in a virtual 3-dimension space displayed on a display screen of a monitor and includes following steps of: (a) preparing a 2-dimension plane map corresponding to the virtual 3-dimension space and a plane map texture including an action restriction area which is rendered on the 2-dimension plane map and restricts an action of the player character; (b) renewing the action restriction area of the plane map texture by moving a non-player character in the virtual 3-dimension space; (c) renewing the action restriction area of the plane map texture by a predetermined movement of the player character in response to an operation of the game player; and (d) changing in real time the action restriction area displayed in the virtual 3-dimension space by rendering the plane map texture having a renewed action restriction area on the 2-dimension plane map.

It is noted that it is possible to renew the action restriction area by a translucency parameter of the plane map texture in the step (b).

In one aspect of the present invention, a game apparatus is a game apparatus in which a player plays a game by operating a player character (76) in a virtual 3-dimension space displayed on a display screen of a monitor, and comprises an obstacle area writing means (36, 72db, S28) for writing onto the screen an obstacle area (82) depending upon a moving locus on which a non-player character (78) moves; a damage means (36, S27) for applying damage to the player character in the obstacle area written by the obstacle area writing means; and an erasing means (36, S27) for erasing the obstacle area in response to an operation of the player.

In this case, when the game apparatus is further provided with a texture generating means, a surface of a still object displayed in the virtual 3-dimension space is formed by texture mapping, and the obstacle area writing means rewrites in real time the surface texture of the still object.

A game program according to the present invention is applied to a video game apparatus having a map data storing means (70c) for storing map data to display a virtual 3-dimension space on a display screen of a monitor, a player character data storing means (70a, 72a) for storing player character data to display a player character (76) in the virtual 3-dimension space, a still object data storing means (72c, 72da) for storing still object data to display a still object (80) in the virtual 3-dimension space, and a processor (36) for displaying the player character and the still object in the virtual 3-dimension space according to the player character data and the still object data, and makes the processor execute following steps of: a setting step (S23) for setting an action restriction area to restrict an action of the player character in the virtual 3-dimension space; a canceling step (S27) for canceling at least a part of the action restriction area set by the setting step in response to a predetermined movement of the player character; an action restriction area renewing step (S28) for storing a latest action restriction area by storing in real time the action restriction area set by the setting step and storing in real time a cancelled area cancelled by the canceling step; and a rendering step (S8) for rendering the action restriction area in the virtual 3-dimension space on the basis of the action restriction area renewed in the action restriction area renewing step.

In a case the video game apparatus further includes a plane map storing means (70d) for storing a 2-dimension plane map corresponding to the virtual 3-dimension space and a plane map texture storing means (72db) for storing a plane map texture rendered in the plane map, the action restriction area is set in the plane map texture in the above-described setting step of the game program, and the plane map texture storing means is renewed in the action restriction area renewing step.

When the video game apparatus further includes a still object data generating means (72c) for generating still object data indicative of a shape of a still object and a still object texture storing means (72d) for storing a still object texture, the processor displays the still object by mapping the still object texture on the still object data, and the still object texture and the plane map texture are mapped with each other in the above-described rendering step of the game program.

In a case the plane map texture storing means is settable of a transparency parameter, the above-described action restriction area renewing step of the game program renews the transparency parameter.

When the video game apparatus further includes a non-player character data storing means (70b, 72b) for storing non-player character data to display a non-player character (78) in the virtual 3-dimension space, the action restriction area is set depending upon a moving locus of the non-player character in the above-described setting step of the game program.

A game system of the embodiment includes the game machine, the controller connected to the game machine and the monitor for displaying a game screen according to a video signal and a sound signal from the game machine. The CPU (and GPU) of the game machine displays the virtual 3-dimension space on the display screen of the monitor according to the map data, displays the player character in the virtual 3-dimension space according to the player character data and further displays the still object by the still object data.

In the embodiment, the enemy character (non-player character) is displayed in the virtual 3-dimension space irrespective of operating of the controller in the game machine, and according to the moving locus of the enemy character, for example, the CPU (setting means) sets the action restriction area to restrict an action of the player character in the virtual 3-dimension space.

When the game player makes by operating the controller the player character perform a predetermined action, including an action of sprinkling water by a pump, the CPU (canceling means) cancels at least a part of the action restriction area set by the enemy character.

Then, the action restriction area is renewed by storing in real time the action restriction area set by the setting means and storing in real time the cancelled area cancelled by the canceling means. Accordingly, the rendering means (CPU and GPU) renders the action restriction area in the virtual 3-dimension space on the basis of the latest action restriction area.

More specifically, the video game apparatus further includes the plane map storing means for storing the 2-dimension plane map corresponding to the virtual 3-dimension space and the plane map texture storing means for storing the plane map texture rendered in the plane map, and the action restriction area is stored as a texture in the plane map texture storing means and renewed in real time. It is noted that a texture indicative of the action restriction area is settable by the translucency parameter.

As a video game, the player character is damaged when entering the action restriction area. Furthermore, when the action restriction area is, for example, increased more than a predetermined percentage of the game screen, a game-over process is performed, and when the action restriction area is, for example, erased, a stage- or map-clear process is performed.

According to the present invention, a novel video game apparatus can be obtained by setting the action restriction area for restricting an action of the player character in the virtual 3-dimension space and making the game be over or the stage be cleared depending upon the action restriction area.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing a game system of one embodiment of the present invention;

FIG. 2 is a block diagram showing in detail a game machine of FIG. 1 embodiment;

FIG. 3 is an illustrative view showing one example of a memory map of a main memory in FIG. 2;

FIG. 4 is an illustrative view showing one example of a game screen for schematically describing a game of the embodiment;

FIG. 5 is an illustrative view showing another example of the game screen for schematically describing the game of the embodiment;

FIG. 6 is an illustrative view showing one example of a plane map texture including an action restriction area (graffiti);

FIG. 7 is a flowchart showing an operation of FIG. 1 embodiment;

FIG. 8 is a flowchart showing an operation of an action restriction area process in FIG. 7;

FIG. 9 is a flowchart showing an operation of a rendering process in FIG. 7; and

FIG. 10 is an illustrative view showing one example of a rendering of the plane map texture.

### DETAILED DESCRIPTION OF THE PREFERRED EMBODIMENTS

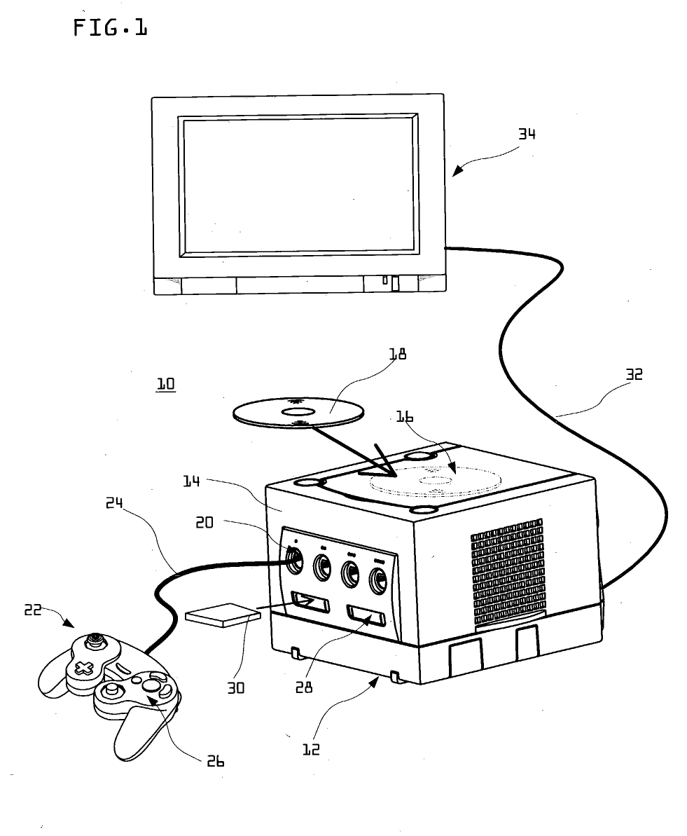

A video game system 10 of this embodiment shown in FIG. 1 includes a video game machine (hereinafter, may simply be referred to as “game machine”) 12. Although a power source is applied to the game machine 12, a general AC adapter (not shown) may be adopted thereto in this embodiment. The AC adapter is inserted into a standard wall socket for home use, and a power source for home use is converted into a low DC voltage signal suitable for driving the game machine 12. In another embodiment, a buttery may be utilized as the power source.

The game machine 12 includes an approximately cubic housing 14, and the housing 14 is provided with an optical disk drive 16 on an upper surface thereof. An optical disk 18 which is one example of an information storage medium stored with a game program is loaded on the optical disk drive 16. The housing 14 is provided with a plurality of connectors 20 (four in this embodiment) on a front surface thereof. These connectors 20 are for connecting a controller 22 to the game machine 12 by a cable 24 and can connect up to four controllers to the game machine 12 in this embodiment.

The controller 22 is provided with an operating means (control) 26 on upper, lower and side surfaces thereof. The operating means 26 includes, for example, two analog joysticks, one cross key, a plurality of button switches and so on. One analog joystick is utilized for inputting a moving direction and/or a moving speed or moving amount, and etc. of a player character (a moving image character operable by the controller 22 by a player) according to an amount of inclination and a direction of the stick. The other analog joystick is utilized for controlling movement of a virtual camera according to a direction of an inclination thereof. The cross key is utilized for instructing a moving direction of the player character in place of the analog joystick. The button switches are utilized for instructing movement of the player character, switching a point of view of the virtual camera in the 3-dimension image, adjusting the moving speed of the player character and so on. The button switches further control, for example, a menu selection and movement of a pointer or a cursor.

It is noted that the controller 22 is connected to the game machine 12 by the cable 24 in this embodiment. However, the controller 22 may be coupled to the game machine 12 via another method, for example, an electromagnetic wave (e.g., radio wave or infrared ray) in a wireless manner. Furthermore, detailed structure of the operating means of the controller 22 is, of course, not limited to the structure of the embodiment and can be arbitrarily changed or modified. For example, only one analog joystick may be utilized or no analog joystick may be utilized. The cross key may not be utilized.

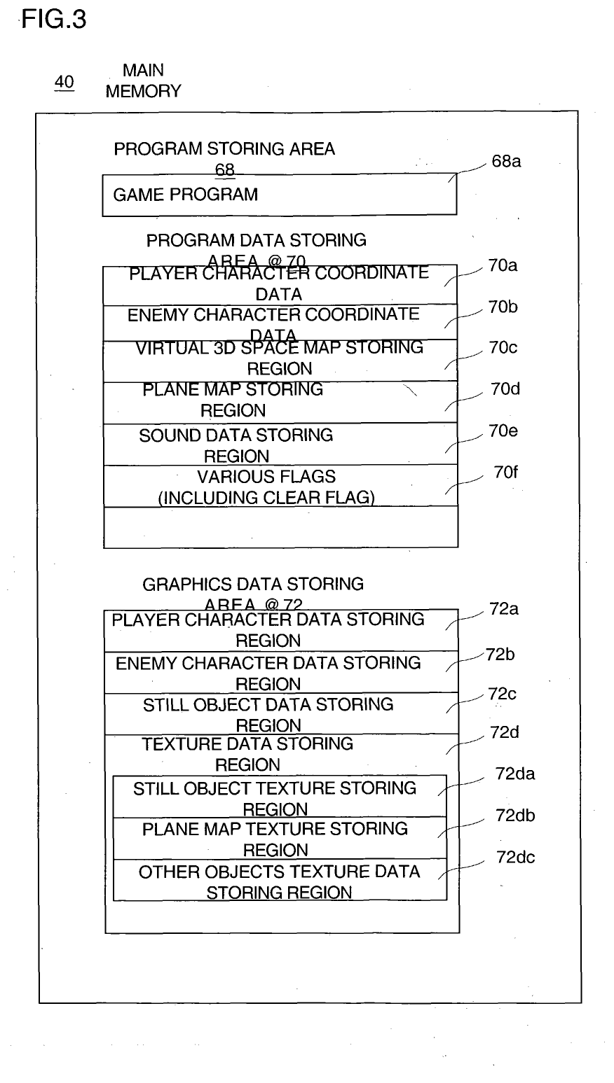

At least one (two in this embodiment) memory slot 28 is provided below the connectors 20 on the front surface of the housing 14 of the game machine 12. A memory card 30 is inserted to this memory slot 28. The memory card 30 is utilized for loading the game program and display data (see FIG. 3) read from the optical disk 18 so as to temporarily store, or saving game data (i.e., result of the game) of the game that the player plays by utilizing the game system 10.

The housing 14 of the game machine 12 is, on a rear surface thereof, provided with an AV cable connector (not shown) with which a monitor 34 is connected to the game machine 12 through an AV cable 32. The monitor 34 is typically a color television receiver, and the AV cable 32 inputs a video signal from the game machine 12 to a video input terminal of the color television and applies a sound signal to a sound input terminal. Accordingly, a game image of a 3-dimension (3D) video game, for example, is displayed on the color television (monitor) 34, and a stereo game sound such as game music, sound effect and etc. is output from right and left speakers.

In the game system 10, a user or a game player turns on an electric power source of the game machine 12 in order to play a game (or other application), and then, selects a suitable optical disk 18 storing a video game (or other application intended to play), and loads the optical disk 18 on the disk drive 16 of the game machine 12. In response thereto, the game machine 12 starts to execute the video game or the other application on the basis of software stored in the optical disk 18. The user operates the controller 22 so as to apply an input to the game machine 12. For example, by operating any one of the operating means 26, the game or the other application is started. By moving another of the operating means 26, it is possible to move the moving image character (player character) toward different directions or to change the point of view of the user (camera position) in the 3-dimension (3D) game world.

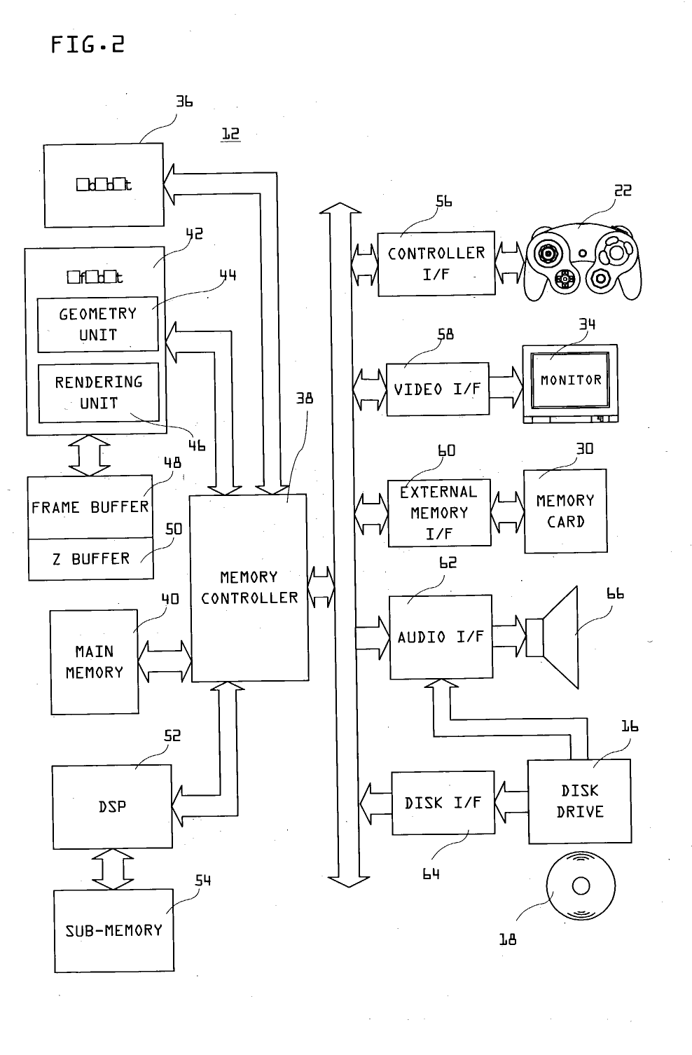

FIG. 2 is a block diagram showing a configuration of the video game system 10 of FIG. 1 embodiment. The video game machine 12 is provided with a central processing unit (hereinafter, may be referred to as “CPU”) 36 for governing overall control of the game machine, and the CPU36 is connected with a memory controller 38 via a bus. The memory controller 38 mainly controls writing and reading of a main memory 40 connected via a bus under control of the CPU 36. The memory controller 38 is coupled with a GPU (Graphics Processing Unit) 42.

The GPU 42 is constructed by, for example, a single chip ASIC and receives a graphics command (an image-construction command) from the CPU 36 via the memory controller 38 and then, in response to the command, generates the 3-dimension (3D) game image by a geometry unit 44 and a rendering unit 46. Specifically, the geometry unit 44 performs a coordinate operation process such as rotation, movement, transformation and etc. of various kinds of characters and objects (which is formed by a plurality of polygons, and the polygon is a polygonal plane defined by at least 3 vertex coordinates) in a 3-dimension coordinates system. The rendering unit 46 pastes (performs a rendering) a texture (pattern image) on each of polygons of the various kinds of objects. Accordingly, 3-dimension image data to be displayed on the game screen is produced by the GPU 42, and the image data is rendered (stored) in a frame buffer 48. It is noted that data (primitive or polygon, texture and etc.) required to execute the image-construction command by the GPU 42 is obtained from the main memory 40 via the memory controller 38.

The frame buffer 48 is a memory for rendering (accumulating) one frame of image data, for example, of the raster scan monitor 34 and is rewritten by the GPU 42 at every one frame. A video I/F 58 described later reads the data stored in the frame buffer 48 through the memory controller 38, and whereby the 3D game image is displayed on the screen of the monitor 34. It is noted that a capacity of the frame buffer 48 has largeness corresponding to the number of pixels (or dots) of the screen to be displayed. For example, it has the number of pixels (storing positions or addresses) corresponding to the number of the pixels of the display or the monitor 34.

Furthermore, a Z buffer 50 has a storage capacity equal to the number of pixels (storing positions or addresses) corresponding to the frame buffer 48×the number of bits of depth data per one pixel, and stores depth information or depth data (Z value) of dots corresponding to respective storing positions of the frame buffer 48.

It is noted that the frame buffer 48 and the Z buffer 50 may be constructed by a portion of the main memory 40.

The memory controller 38 is also connected to a sub-memory 54 via a DSP (Digital Signal Processor) 52. Accordingly, the memory controller 38 controls the writing and/or the reading of the sub-memory 54 in addition to the main memory 40.

The memory controller 38 is further connected to respective interfaces (I/F) 56, 58, 60, 62 and 64 by buses. The controller I/F 56 is an interface for the controller 22 and applies an operating signal or data of the operating means 26 of the controller 22 to the CPU 36 through the memory controller 38. The video I/F 58 accesses the frame buffer 48 to read the image data formed by the GPU 42 and then, applies the image signal or the image data (digital RGB pixel values) to the monitor 34 via the AV cable 32 (FIG. 1). The external memory I/F 60 makes the memory card 30 (FIG. 1) which is inserted to the front surface of the game machine 12 communicate to the memory controller 38. This allows the CPU 36 to write the data to the memory card 30 (FIG. 1) or read the data from the memory card 30 via the memory controller 38. The audio I/F 62 receives audio data applied from the frame buffer 48 through the memory controller 38 or an audio stream read from the optical disk 18, and then applies an audio signal (sound signal) corresponding thereto to a speaker 66 of the monitor 34. It is noted that in a stereo sound, the speaker 66 is provided right and left at least one. The disk I/F 64 connects the disk drive 16 to the memory controller 38, and whereby the CPU 36 controls the disk drive 16. The disk drive 16 writes program data, texture data and etc. read from the optical disk 18 to the main memory 40 under control of the CPU 36.

FIG. 3 shows a memory map of the main memory 40. The main memory 40 includes a program storing area 68, a program data storing area 70 and a graphics data storing area 72. The game program storing area 68 is stored with a game program 68a read from the optical disk 18 wholly at one time, or partially and sequentially.

The program data storing area 70 is similarly stored with program data read from the optical disk 18 wholly at one time, or partially and sequentially. The program data includes coordinates data of a model of a character or an object, for example. The program data storing area 70 includes a player character coordinate data storing region 70a for storing coordinate data of a character (player character) capable of being moved or rendered an arbitrary action within the game space by operating the controller 38 by the game player, and an enemy character coordinate data storing region 70b for storing coordinate data of an enemy character. It is noted that although the enemy character is one of non-player characters (character incapable of being operated or controlled by the game player), the non-player character may includes a non-player character except for the enemy character. The program data storing area 70 further includes a storing region 70c for storing a map (virtual 3-dimension space map) to display a virtual 3-dimension game space, a region 70d for storing a plane map showing a plane obtained by viewing from above the virtual 3-dimension game space, a region 70e for storing sound data of a game sound and a sound effect, and a region 70f for a various flags including, for example, a clear flag, and registers. The clear flag is set to “1” when graffiti (an action restriction area or obstacle area) described later is present in the game space and set to “0” when the graffiti becomes absent.

The graphics data storing area 72 is also stored with graphics data read from the optical disk 18 wholly at one time, or partially and sequentially. The graphics data is, for example, data relating to a rendering such as color, transparency and etc. The graphics data storing area 72 includes a storing region 72a for storing data such as a polygon of the above-described player character (polygon list and so on) and etc., a storing region 72b for storing data such as a polygon of the enemy character (polygon list and so on) and etc., a storing region 72c for storing data such as a polygon of the still object (wall object, land object and so on) and etc., and a storing region 72d for storing texture data. The texture data storing region 72d includes a storing region 72da for storing a still object texture to be pasted on each surface of the above-described still object, a storing region 72db for storing a plane map texture to be pasted on the above-described plane map, and a storing region 72dc for storing texture to be pasted on other objects or characters. The above-described plane map texture is a texture for pasting only after-mentioned graffiti on the plane map, includes, for example, a black graffiti pattern, and is renewed in real time as described later. In other words, the plane map texture is for eventually deciding RGB (color) to be specified at every pixel of the still object. On the other hand, the plane map texture is settable of transparency (•) at every pixel. By use of this, if •=1 (opaque) as to a portion subjected to graffiti, a color of the still object becomes black as graffiti at the portion of •=1. As described later, if the graffiti is erased, a portion of the still object is made •=0 (transparency), the black texture disappears, and whereby, a natural color of the still object is displayed. Of course, a process for directly rewriting the RGB data may be performed.

As a game content of this embodiment, when the player character moves in a town and etc. in the game space, a smudged portion or “graffiti portion” exists here and there. When the player character touches the graffiti portion, a contrivance such as suffering of damage, incapability of entering in the graffiti portion and etc. is performed. Accordingly, the graffiti portion limits the action of the player character and is called an “action restriction area” or an “obstacle area”.

On the other hand, when the enemy character moves, since a movement locus is changed to the graffiti portion, the graffiti portion in which the player character is damaged is increased, and therefore, a range in which the player character can freely act becomes narrower.

It is noted that the player character can sprinkle water by utilizing a water pump and erase the graffiti, and when all the graffiti on the map is erased, the map or the stage means to be cleared.

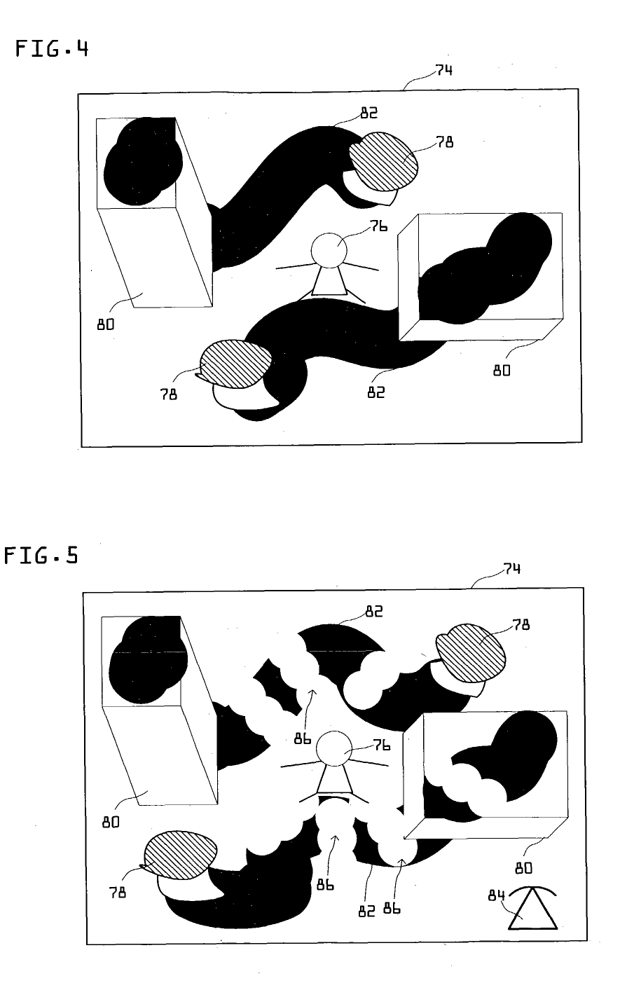

Herein, referring to FIG. 4 to FIG. 6, an outline of the video game machine of this embodiment is described. A game image shown in FIG. 4, for example, is displayed on the monitor 34 shown in FIG. 1. That is, a game space 74 is displayed as the virtual 3-dimension space in which a player character 76 is displayed. In relation to the player character 76, one or more enemy character 78 being the non-player character is displayed. An arbitrary number of still objects 80 such as land (floor), building, wall and etc. are displayed in the game space 74. In FIG. 4, black graffiti 82 is displayed on a part of the still object 80. The graffiti 82 functions as the action restriction area with respect to the player character 76.

More specifically, when the player character 76 enters in the area, i.e., the graffiti 82, the player character 76 drains physical strength, for example and decreases a so-called life point (HP) in the game. Accordingly, as the game player, it is necessary to deal with the problems by letting the player character away from the graffiti 82 as soon as possible, erasing the graffiti 82 and so on.

In this embodiment, when the game player operates the controller 22 so as to allow the player character to operate a pump 84 shown in FIG. 5, it is possible to erase a part of the graffiti 82 as shown in FIG. 5. In a graffiti cancelled portion 86, an action restriction with respect to the player character 76 is canceled.

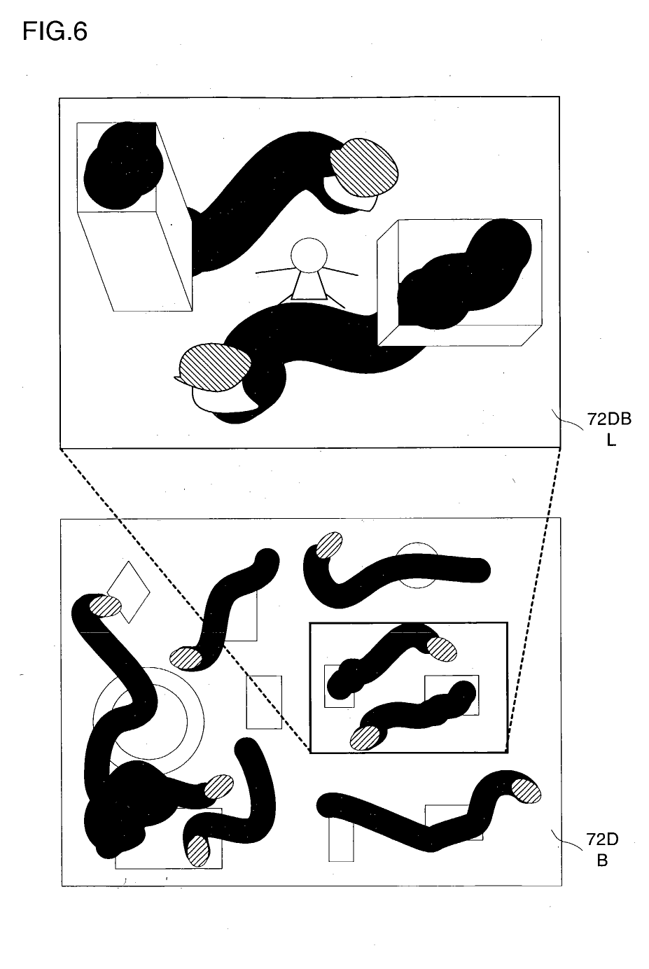

It is noted that although a plane map texture stored in the plane map texture storing region 72db in FIG. 3 has largeness so as to wholly cover the game space in the same manner as a texture 72DB shown in FIG. 6, a part 72DB′ of the texture is utilized in FIG. 4 and FIG. 5.

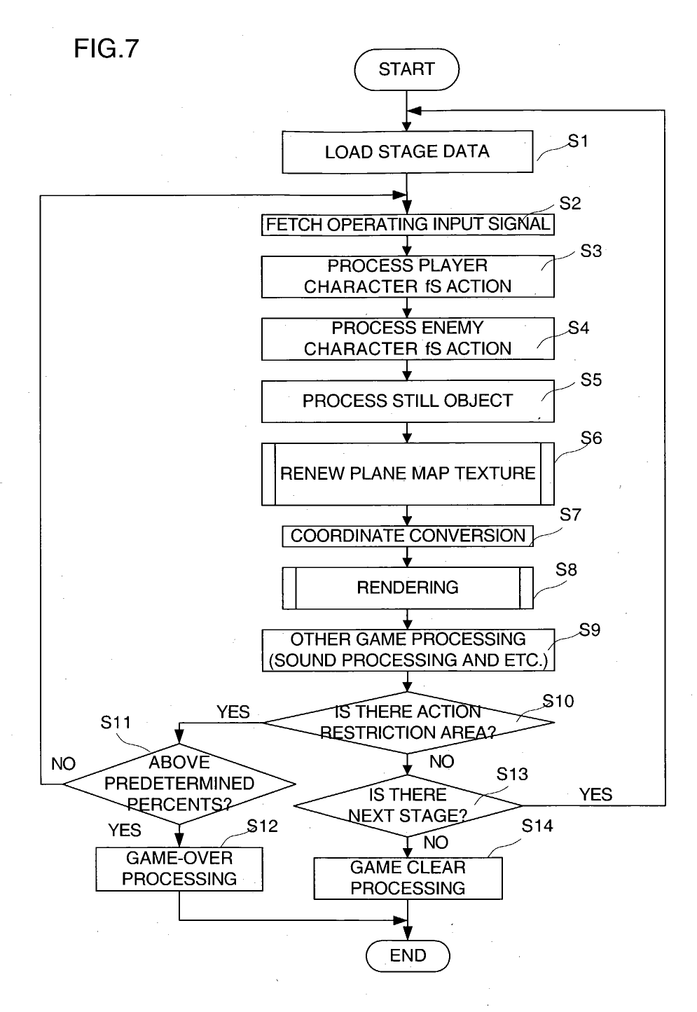

When playing a game, the optical disk 18 is set to the game machine 12 as described above. When the power is turned on, data is read from the optical disk 18, and a program and data required for a game map or a stage at this time are stored (loaded) in the main memory 40 as shown in FIG. 3 in a first step S1 in FIG. 7. Then, in the step S1, although not shown in detail, the CPU 36 reads from the graphics data storing area 72 of the main memory 40 a geography object (land object, building object, wall object and etc.), an item, the player character, the non-player character (enemy character) and data of the virtual camera and arranges the graphics data thereof in initial coordinates of the 3-dimension world coordinates system being the virtual 3-dimension game space. Accordingly, in the step S1, the game screen as shown in FIG. 4 is displayed on the monitor 34 (FIG. 1).

Then, the CPU 36 fetches an operating input signal from the controller 22 in a next step S2, and operates the player character 76 (FIG. 4) in response to the operating input signal in a following step S3. For example, in a case the game player operates a direction instructing means (e.g., cross key or analog joystick) of the controller 22, the CPU 36 moves the player character to the direction within the game space in the step S3. For example, when a motion instructing means (e.g., A button) is operated, the player character is, for example, jumped in the step S3.

The CPU 36 executes a moving process of the enemy character in a following step S4 and, at the same time, executes a process of the still object in a next step S5.

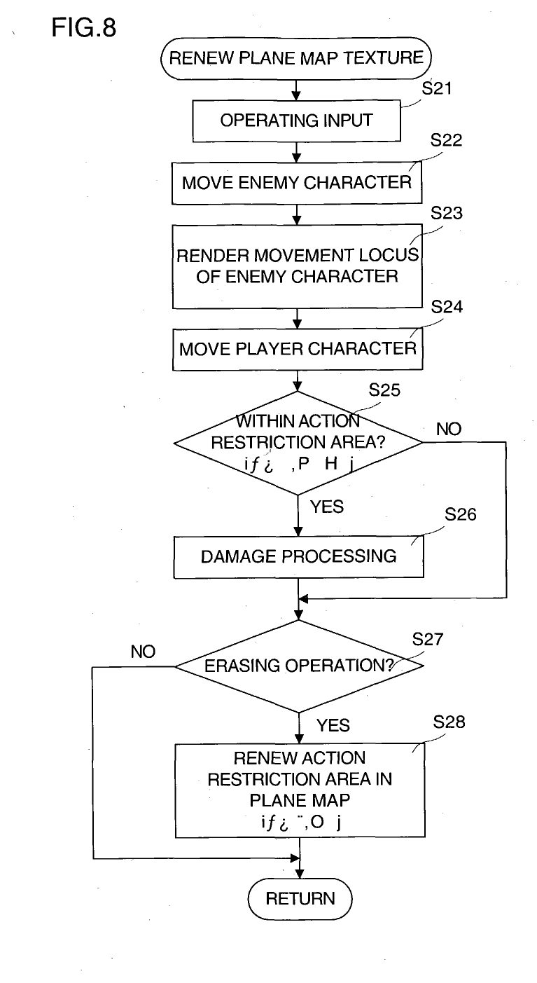

In a following step S6, the CPU 36 processes the action restriction area. The action restriction area is specifically shown in detail in FIG. 8.

In a first step S21 in FIG. 8, the CPU 36 fetches the operating input signal obtained by operating the operating means 26 (FIG. 1) of the controller 22 via the controller I/F 56 and the memory controller 38. Then, the CPU 36 moves the enemy character in a following step S22, and renders a movement locus of the moved enemy character in a following step S23. Then, in a following step S24, the CPU 36 moves the player character 76 in response to the operating input signal from the controller. That is, the CPU 36 changes a position of the player character in response to the controller input in the world coordinates system in the step S24. The game player operates the analog joystick (or 3D joystick), for example, out of the operating means 26 (FIG. 1) of the controller 22 in a case of changing the position of the player character 76 shown in FIG. 4, and therefore, the CPU 36 receives data of a direction of an inclination and an amount of the inclination of the joystick from the controller I/F 56 and renews the position of the player character 76 on the basis of the data in the step S24.

At the same time, it is determined whether or not the player character 76 exists in the action restriction area in a step S25. More specifically, the CPU 36 determines whether or not the player character exists within the action restriction area by comparing the position of the player character at that time with a range of the coordinate position of the action restriction area (i.e., graffiti 82) shown in FIG. 4.

If “YES” is determined in the step S25, the CPU 36 applies predetermined damage to the player character and executes processes such as decrease of the life point (HP) and etc. in a following step S26. In contrast, if “NO” is determined in the step S25, the process directly proceeds to a step S27.

In the step S27, the CPU 36 sees the operating input signal from the controller fetched in the step S21 and determines whether or not an instruction for erasing the action restriction area (graffiti) is included in the signal. If the erasing means is the pump 84 (FIG. 5), the CPU 36 determines whether or not the game player operates the controller so that the pump is operable by the player character. If “NO” is determined in the step S27, the process directly returns to previous FIG. 7 while if “YES” is determined, the plane map texture is renewed in response to the operation of the erasing means in a step S28.

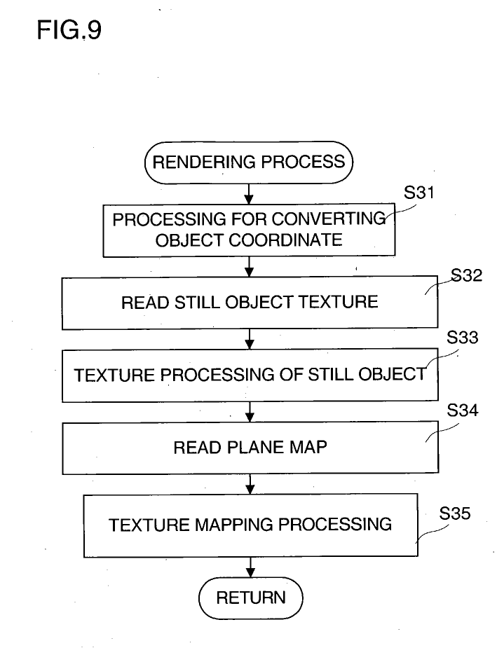

Returning to FIG. 7, in a step S7, the CPU 36 renews the position of the virtual camera in the world coordinate system according to the position of the player character renewed in the step S24 (FIG. 8). Then, in a step S8, a rendering process is executed. The step S8 is described in detail in FIG. 9.

In a step S31, first, the CPU 36 converts the positions of the above-described geography object, the building object, the item, the player character, the enemy character and etc. into the 3-dimension camera coordinates system making the virtual camera as a reference, and converts the 3-dimension camera coordinates system into a 2-dimension projection plane coordinates system. Then, the CPU 36 reads a texture of the still object from the still object texture storing region 72da shown in FIG. 3 in a step S32 and renders the still object texture in a step S33.

Furthermore, the plane map texture renewed in the above-described step S28 is read in a step S34, and the plane map texture is mapped on the previous still object texture in a step S35. Accordingly, by executing the step S35, the game screen shown in FIG. 5 on which the erasing operation detected in the step S27 is reflected, i.e., in which a part of the graffiti is erased is displayed.

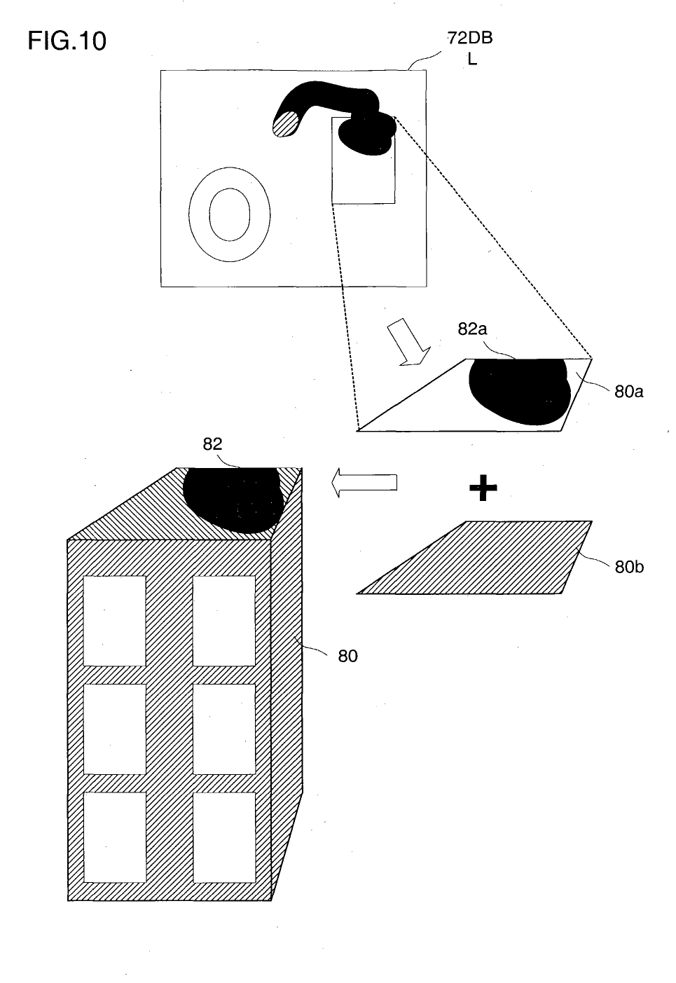

Referring to FIG. 10, the plane map texture 72DB′ shown in FIG. 10 is read, and therein, a graffiti pattern 82a exists at a position or place corresponding to an upper surface 80a of the building 80. On the other hand, a natural texture of the building 80 is denoted by a reference numeral 82b. In this case, the graffiti pattern 82a included in the plane map texture 72DB′ is overwritten, and the graffiti pattern 82 is rendered on the upper surface of the building.

Thereafter, the process returns to a step S9 shown in FIG. 7 so as to execute a game process such as game music, sound effect, words and etc. Then, in a step S10, the CPU 36 determines whether or not the action restriction area, i.e., graffiti 82 shown in FIG. 4 remains on the game screen. If the graffiti 82 remains, the CPU 36 calculates a ratio of a remaining graffiti 82 to the whole game screen (game space) 74 (FIG. 4) and determines whether or not the ratio is more than a constant percentage in a following step S11.

If “NO” is determined in the step S11, i.e., a remaining ratio of the graffiti 82 is smaller than the constant percentage, the process returns to the previous step S2. However, in the embodiment which makes the game be over if the graffiti, i.e., the action restriction area 82 more than the constant percentage remains, a game-over process is performed in a step S12 and then, the process is ended.

If “NO” is determined in the previous step S10, the CPU 36 determines whether or not a next stage is present in a following step S13. If the next stage is present, the process returns to the first step S1 while if the next stage is absent, the game is cleared and a game clear process is executed in a step S14, and then, the process is ended.

Although the present invention has been described and illustrated in detail, it is clearly understood that the same is by way of illustration and example only and is not to be taken by way of limitation, the spirit and scope of the present invention being limited only by the terms of the appended claims.

1. A video game apparatus, comprising:
a map data storing means for storing map data to display a virtual 3-dimension space on a display screen of a monitor;
a player character data storing means for storing player character data to display a player character in said virtual 3-dimension space;
a still object data storing means for storing still object data to display a still object in said virtual 3-dimension space;
a setting means for setting an action restriction area to restrict an action of said player character in said virtual 3-dimension space;
a canceling means for canceling at least a part of said action restriction area set by said setting means in response to a predetermined action of said player character;
an action restriction area storing means for storing a latest action restriction area by storing in real time said action restriction area set by said setting means and storing in real time a cancelled area cancelled by said canceling means; and
a rendering means for rendering said action restriction area in said virtual 3-dimension space on the basis of said action restriction area stored in said action restriction area storing means.

2. A video game apparatus according to claim 1, further comprising a clear determining means for determining whether or not a stage is cleared on the basis of said latest action restriction area stored in said action restriction area storing means.

3. A video game apparatus according to claim 1, further comprising a game-over determining means for determining whether or not a game is over on the basis of said latest action restriction area stored in said action restriction area storing means.

4. A video game apparatus according to claim 1, further comprising a plane map storing means for storing a 2-dimension plane map corresponding to said virtual 3-dimension space, and a plane map texture storing means for storing a plane map texture rendered in said plane map, wherein
said action restriction area setting means sets said action restriction area in said plane map texture, and said action restriction area storing means includes the plane map texture storing means.

5. A video game apparatus according to claim 4, further comprising a still object data generating means for generating still object data indicative of a shape of said still object and a still object texture storing means for storing a still object texture, wherein said still object is displayed by mapping said still object texture on said still object data, and
said rendering means includes a texture mapping means for mapping said still object texture and said plane map texture.

6. A video game apparatus according to claim 4, wherein said plane map texture storing means is settable of a transparency parameter, and
said action restriction area is set by said transparency parameter.

7. A video game apparatus according to claim 1, further comprising a non-player character data storing means for storing non-player character data to display a non-player character in said virtual 3-dimension space, wherein
said action restriction area setting means sets an action restriction area depending upon a moving locus of said non-player character.

8. A control method of a video game in which a game player operates a player character in a virtual 3-dimension space displayed on a display screen of a monitor, comprising steps of:
(a) preparing a 2-dimension plane map corresponding to said virtual 3-dimension space and a plane map texture including an action restriction area which is rendered on said 2-dimension plane map and restricts an action of said player character;
(b) renewing said action restriction area of said plane map texture by moving a non-player character in said virtual 3-dimension space;
(c) renewing said action restriction area of said plane map texture by a predetermined movement of said player character in response to an operation of said game player; and
(d) changing in real time said action restriction area displayed in said virtual 3-dimension space by rendering said plane map texture having a renewed action restriction area in said 2-dimension plane map.

9. A control method according to claim 8, wherein said step (b) renews said action restriction area by a transparency parameter of said plane map texture.

10. A game apparatus in which a player plays a game in a virtual 3-dimension space displayed on a display screen by operating a player character, comprising:
an obstacle area writing means for writing to the screen an obstacle area depending upon a moving locus of a non-player character;
a damage means for applying damage to said player character in said obstacle area written by said obstacle area writing means; and
an erasing means for erasing said obstacle area in response to an operation of said player.

11. A video game apparatus according to claim 10, further comprising a texture generating means, wherein
a surface of a still object displayed in said virtual 3-dimension space is formed by a texture mapping,
said obstacle area writing means rewrites in real time a surface texture of said still object.

12. In a video game apparatus provided with a map data storing means for storing map data to display a virtual 3-dimension space on a display screen of a monitor, a player character data storing means for storing player character data to display a player character in said virtual 3-dimension space, a still object data storing means for storing still object data to display a still object in said virtual 3-dimension space, and a processor for displaying said player character and said still object in said virtual 3-dimension space according to said player character data and said still object data, a game program makes said processor execute following steps of:
a setting step for setting an action restriction area to restrict an action of said player character in said virtual 3-dimension space;
a canceling step for canceling at least a part of said action restriction area set by said setting step in response to a predetermined action of said player character;
an action restriction area renewing step for storing a latest action restriction area by storing in real time said action restriction area set by said setting step and storing in real time a cancelled area cancelled by said canceling step; and
a rendering step for rendering said action restriction area in said virtual 3-dimension space on the basis of said action restriction area renewed in said action restriction area renewing step.

13. A game program according to claim 12, wherein
said game apparatus further includes a plane map storing means for storing a 2-dimension plane map corresponding to said virtual 3-dimension space, and a plane map texture storing means for storing a plane map texture rendered in said plane map, and
said action restriction area is set in said plane map texture in said setting step, and
said plane map texture storing means is renewed in said action restriction area renewing step.

14. A game program according to claim 13, wherein
said game apparatus further includes a still object data generating means for generating still object data indicative of a shape of said still object, and a still object texture storing means for storing a still object texture, and said processor displays said still object by mapping said still object texture on said still object data, and
said still object texture and said plane map texture are mapped with each other in said rendering step.

15. A game program according to claim 13, wherein said plane map texture storing means is settable of a transparency parameter, and said action restriction area renewing step renews said transparency parameter.

16. A game program according to 12, wherein
said game apparatus includes a non-player character data storing means for storing non-player character data to display non-player character in said virtual 3-dimension space, and
said action restriction area is set depending upon a moving locus of said non-player character in said setting step.
